(19) United States
(12) Patent Application Publication
(10) Pub. No.: US 2009/0195462 A1
(43) Pub. Date: Aug. 6, 2009

(54) ANTENNA AND COMMUNICATION DEVICE

(75) Inventors: Ming-Iu Lai, Taipei (TW); Chun-Hsiung Wang, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: ASUSTeK COMPUTER INC., Taipei (TW)

(21) Appl. No.: 12/266,538

(22) Filed: Nov. 6, 2008

(30) Foreign Application Priority Data
Feb. 4, 2008 (TW) 97104266

(51) Int. Cl. H01Q 1/38; H01Q 1/24

(52) U.S. Cl. 343/702; 343/700 MS

(57) ABSTRACT

An antenna including a substrate, a ground layer, a conductive sheet and a feeding microstrip line is provided. The substrate has an upper surface and a lower surface. The ground layer is disposed at the lower surface. The conductive sheet is disposed at the substrate, substantially perpendicular to the ground layer and electrically connected to the ground layer. The feeding microstrip line is electrically connected to the conductive sheet. The antenna may be used in a communication device.

### CROSS-REFERENCE TO RELATED APPLICATION

This application claims the priority benefit of Taiwan application serial no. 97104266, filed on Feb. 4, 2008. The entirety of the above-mentioned patent application is hereby incorporated by reference herein and made a part of this specification.

### BACKGROUND OF THE INVENTION

1. Field of the Invention

The invention relates to an antenna and a communication device and, more particularly, to a size-reduced antenna and a size-reduced communication device.

2. Description of the Related Art

With the development of hardware equipment and technology used in wireless transmission, the reception and transmission of data between different electronic devices are gradually improved to be wireless ones from wired ones.

A conventional slot antenna made of sheet metal occupies large area of a circuit board even though it is a single antenna. However, the multiple-input multiple-output (MIMO) technology is a mainstream technology used in the wireless transmission in the future. Multiple antennas in the MIMO system operates together, which is different from operation designs of a conventional single antenna. This makes the wireless network transmit data more steady and increases data transmission quantity. If the MIMO system is formed by the slot antennas, the occupied area of the circuit board certainly greatly increases, and the area for disposing other elements decreases. Therefore, it is difficult to use the MIMO system formed by the slot antennas in a small electronic device.

A chip antenna which is formed by integrating an antenna in a chip is size-reduced and adapted to be used in the small electronic device. However, the cost of the chip antenna is higher, and this makes the small electronic device which uses the chip antenna uncompetitive in price.

### BRIEF SUMMARY OF THE INVENTION

The invention provides an antenna, which is size-reduced and has a low cost.

The invention provides a communication device, the antenna used in the communication device is size-reduced and has a low cost.

The antenna in the invention includes a substrate, a ground layer, a conductive sheet and a feeding microstrip line. The substrate has an upper surface and a lower surface. The ground layer is disposed at the lower surface, and the conductive sheet is disposed at the substrate, substantially perpendicular to the ground layer and electrically connected to the ground layer. The feeding microstrip line is electrically connected to the conductive sheet.

In an embodiment, a first conductive sheet of the antenna is bent to be L-shaped.

In an embodiment, the ground layer has a groove. The groove divides the ground layer into a first portion and a second portion. The first conductive sheet is connected to the second portion. In addition, the first conductive sheet is, for example, bent to be L-shaped, and the second portion is L-shaped. Moreover, the ground layer has, for example, an opening. The first feeding microstrip line has a first end, a second end and a middle portion connected to the first end and the second end. The middle portion is at the upper surface. The first end passes through the substrate to be electrically connected to the second portion. The second end passes through the substrate to be disposed at the opening.

In an embodiment, the first conductive sheet of the antenna is disposed at the upper surface and electrically connected to the ground layer via a conductive via passing through the substrate. In addition, the ground layer has, for example, an opening. The first feeding microstrip line passes through the substrate to be disposed at the opening.

In an embodiment, the antenna further includes at least a second conductive sheet and at least a second feeding microstrip line. The second conductive sheet is disposed at the substrate, substantially perpendicular to the ground layer and electrically connected to the ground layer. The second feeding microstrip line is electrically connected to the second conductive sheet.

The communication device in the invention includes a battery and the antenna. The first conductive sheet and the battery are located at the upper surface and the lower surface of the substrate, respectively, or the first conductive sheet and the battery are located at the lower surface and the upper surface of the substrate, respectively.

In an embodiment, both the second conductive sheet and the battery of the communication device are located at the upper surface or the lower surface of the substrate, but they are located in different areas of the upper surface or the lower surface.

In an embodiment, the communication device further includes a display panel. Both the first conductive sheet and the display panel are located at the upper surface or the lower surface of the substrate, but they are located in different areas of the upper surface or the lower surface.

To sum up, in the invention, the conductive sheet used to receive and send signals is disposed to be substantially perpendicular to the ground layer in the antenna and communication device. Therefore, area occupied by the conductive sheet on the substrate decreases, and the volume of the communication device is reduced. At the same time, the cost of the antenna in the invention is much lower than the chip antenna.

These and other features, aspects and advantages of the present invention will become better understood with regard to the following description, appended claims, and accompanying drawings.

### BRIEF DESCRIPTION OF THE DRAWINGS

FIG. 1 is a three-dimensional schematic diagram showing an antenna in the embodiment of the invention.

FIG. 2 is a three-dimensional schematic diagram showing an antenna in another embodiment of the invention.

FIG. 3 and FIG. 4 are diagrams showing frequency response of reflectance of the antenna in FIG. 1 and FIG. 2.

FIG. 5A to FIG. 5C are pattern diagrams showing the patterns of the antenna in FIG. 1 in XY plane, XZ plane and YZ plane.

FIG. 6A to FIG. 6C are pattern diagrams showing the patterns of the antenna in FIG. 2 in XY plane, XZ plane and YZ plane.

FIG. 7 is a schematic diagram showing an antenna in another embodiment of the invention.

FIG. 8 is a schematic diagram showing a communication device in an embodiment of the invention.

### DETAILED DESCRIPTION OF THE EMBODIMENTS

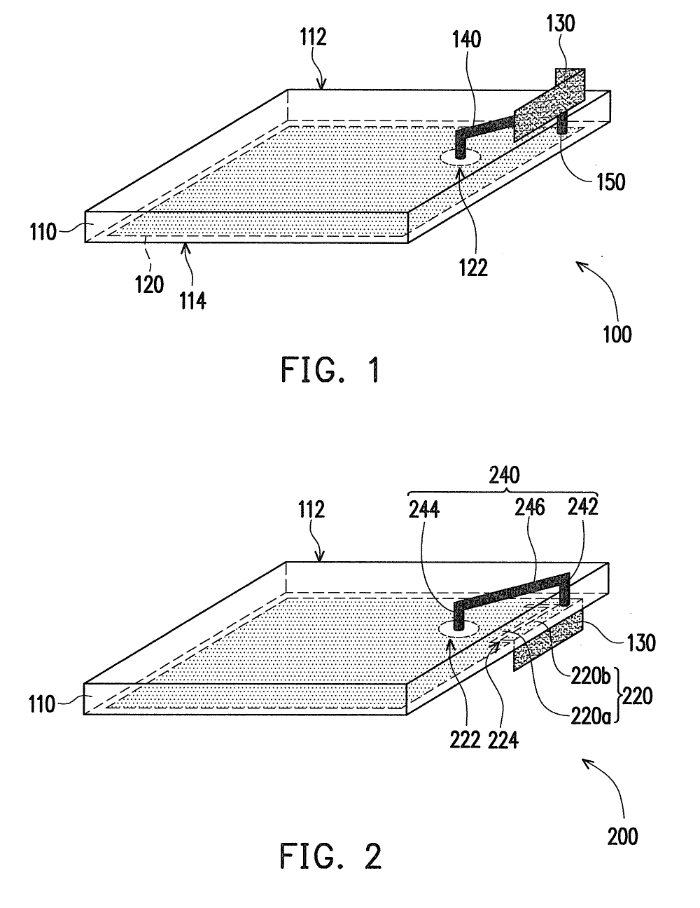

FIG. 1 is a three-dimensional schematic diagram showing an antenna in the embodiment of the invention. As shown in FIG. 1, the antenna 100 in the embodiment includes a substrate 110, a ground layer 120, a conductive sheet 130 and a feeding microstrip line 140. The substrate 110 has an upper surface 112 and a lower surface 114. The ground layer 120 is disposed at the lower surface 114. The conductive sheet 130 in the embodiment is disposed at the upper surface 112 of the substrate 110. However, the conductive sheet 130 also may be disposed at the lower surface 114 of the substrate 110 or other sides which are not denoted. The conductive sheet 130 is substantially perpendicular to the ground layer 120 and electrically connected to the ground layer 120. The material of the conductive sheet 130 may be metal or other conductive materials. The feeding microstrip line 140 is electrically connected to the conductive sheet 130. A signal sent by the antenna 100 is input via a signal line (not shown) electrically connected to the feeding microstrip line 140. The signal received by the antenna 100 is outputted to the signal line via the feeding microstrip line 140.

Since the conductive sheet 130 in the antenna 100 is set to be substantially perpendicular to the ground layer 120, the conductive sheet 130 does not occupy much area of the substrate 110. In other words, much area on the substrate 110 of the antenna 100 may be used to dispose other electronic elements. Therefore, the antenna 100 in the embodiment is adapted to be used in a small communication device such as a mobile phone. Compared with the chip antenna, the antenna 100 in the embodiment has a low cost.

As shown in FIG. 1, in the embodiment, the conductive sheet 130 is, for example, bent to be L-shaped. However, the conductive sheet 130 also may be strip-shaped or has other proper shapes. When other electronic elements are disposed on the substrate 110, they should keep a proper distance from the conductive sheet 130 to avoid interfering in the reception and transmission of the signal. Therefore, when the total length is the same, an L-shaped conductive sheet 130 only occupies a corner of the substrate 110, while a strip-shaped conductive sheet 130 occupies more area at the side of the substrate 110. Therefore, the L-shaped conductive sheet 130 is favorable for reducing the volume of the antenna 100 of the communication device.

In addition, the feeding microstrip line 140 in the embodiment is connected to the bended portion of the L-shaped conductive sheet 130, which is not used to limit the scope of the invention. Furthermore, the conductive sheet 130 in the embodiment is electrically connected to the ground layer 120 via a conductive via 150 passing through the substrate 110. The conductive via 150 in the embodiment is connected to an end of the short side of the L-shaped conductive sheet 130. In FIG. 1, the conductive via 150 is covered by the conductive sheet 130, and only a section which is near the ground layer 120 can be seen. In addition, the ground layer 120 has, for example, an opening 122. After being connected to the conductive sheet 130, the feeding microstrip line 140 passes through the substrate 110, and it is disposed at the opening 122 and connected to the signal line. That is, the feeding microstrip line 140 does not contact the ground layer 120. However, the feeding microstrip line 140 may not pass through the substrate 110, and it is directly connected to the signal line (not shown) at the upper surface 112 of the substrate 110.

FIG. 2 is a three-dimensional schematic diagram showing an antenna in another embodiment of the invention. As shown in FIG. 2, the antenna 200 in the embodiment is similar to the antenna 100 in FIG. 1. Thus, only the differences are described hereinbelow. The ground layer 220 in the embodiment has a groove 224. The groove 224 divides the ground layer 220 into a first portion 220a and a second portion 220b. The conductive sheet 130 is connected to the second portion 220b of the ground layer 220. The first portion 220a and the second portion 220b may be connected to each other. The second portion 220b is L-shaped. The conductive sheet 130 is also L-shaped. The shapes of the second portion 220b and the conductive sheet 130 also may be other shapes and are not necessarily corresponding to each other. The second portion 220b is located at the corner of the ground layer 220 to reserve more area for other electronic elements on the substrate 110. When the area of the second portion 220b is continuously minified to be zero, this embodiment is similar to the first embodiment. The feeding microstrip line 240 in the embodiment has a first end 242, a second end 244 and a middle portion 246 connected to the first end 242 and the second end 244. The middle portion 246 is located at the upper surface 112 of the substrate 110. The first end 242 passes through the substrate 110 to be electrically connected to the second portion 220b. The second end 244 passes through the substrate 110 to be disposed at an opening 222 of the ground layer 220.

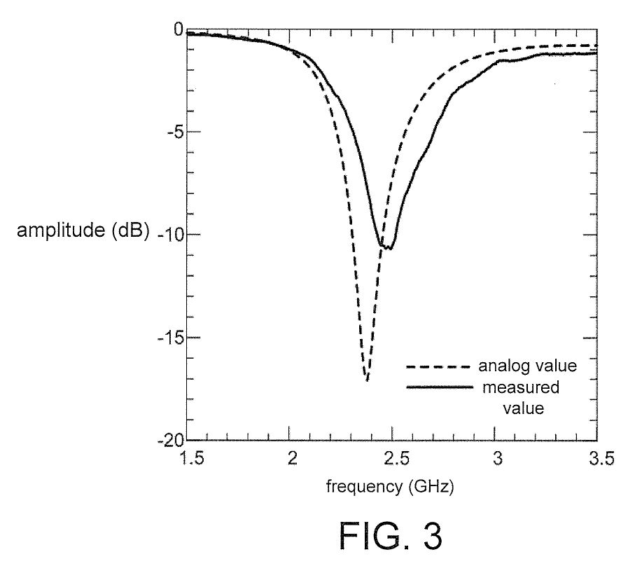

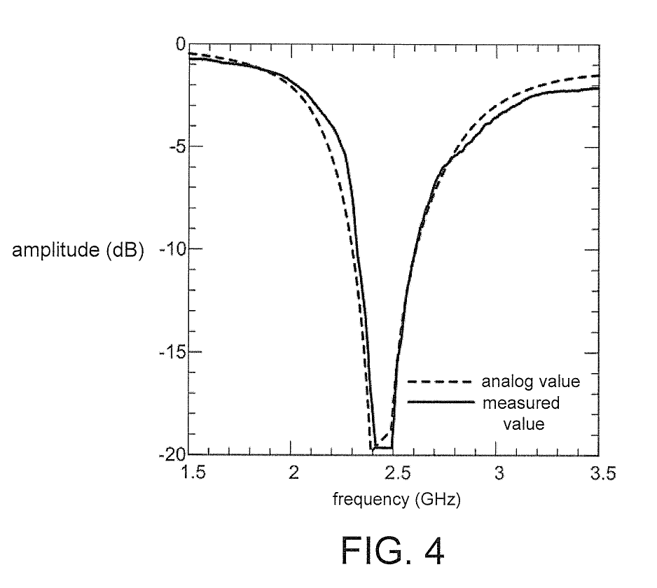

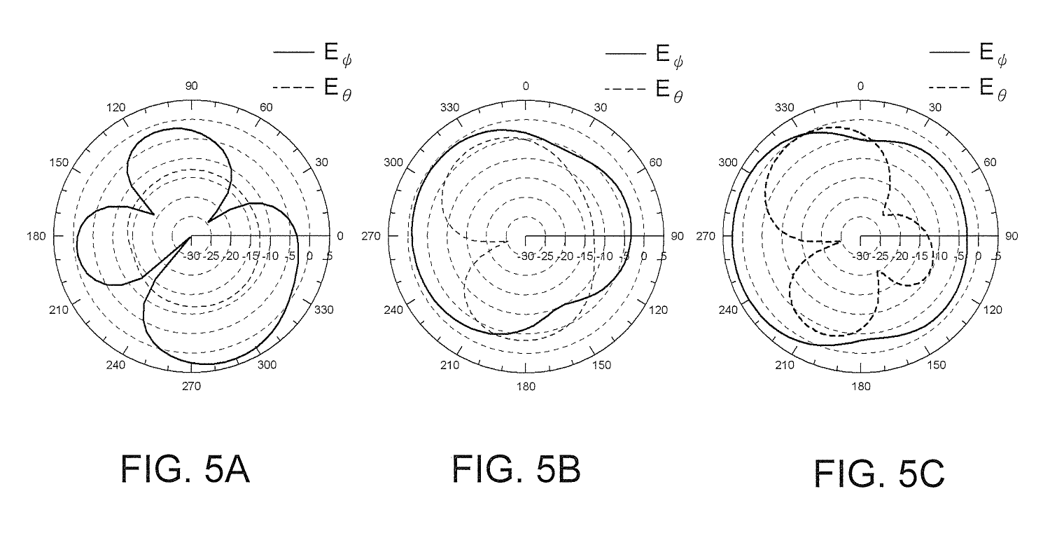

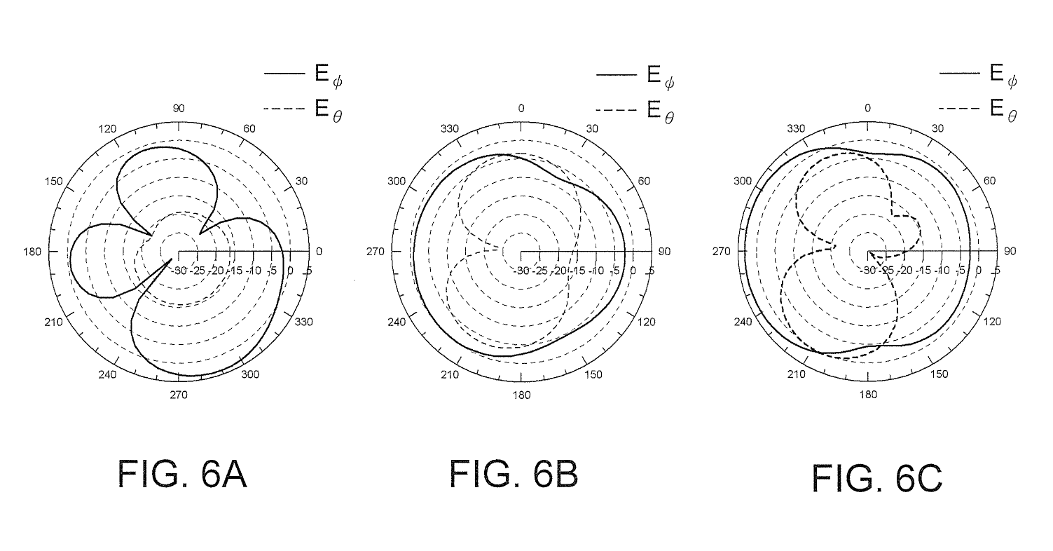

FIG. 3 and FIG. 4 are diagrams showing a frequency response of a reflectance of the antenna in FIG. 1 and FIG. 2. As shown in FIG. 3 and FIG. 4, when the range of working frequency of the antennas in FIG. 1 and FIG. 2 is designed to be 2.4 GHz to 2.5 GHz, the reflection coefficients of the antennas in the range of the working frequency are good. FIG. 5A to FIG. 5C are pattern diagrams showing the patterns of the antenna in FIG. 1 in XY plane, XZ plane and YZ plane. FIG. 6A to FIG. 6C are pattern diagrams showing the patterns of the antenna in FIG. 2 in XY plane, XZ plane and YZ plane. In FIG. 5A to FIG. 5C and FIG. 6A to FIG. 6C, the solid line stands for E_{ψ} and the dash line stands for E_{θ}. As shown in the pattern diagrams, the radiation patterns of the antennas in FIG. 1 and FIG. 2 are good.

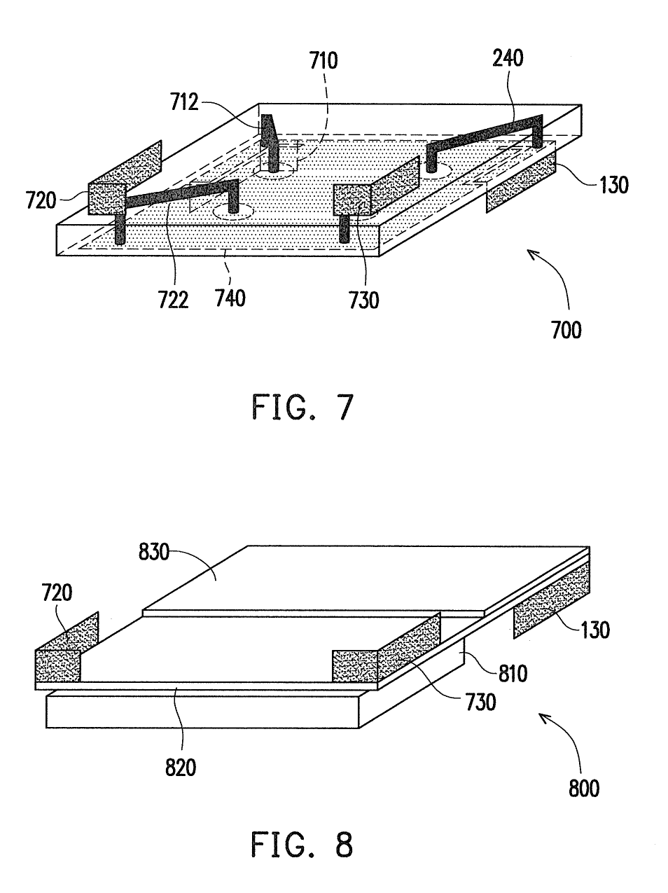

FIG. 7 is a schematic diagram showing an antenna according to another embodiment of the invention. As shown in FIG. 7, compared with the antenna 200 in FIG. 2, the antenna 700 in the embodiment further includes three conductive sheets 710, 720 and 730, and the corresponding feeding microstrip lines 712 and 722. The feeding microstrip line corresponding to the conductive sheet 730 cannot be seen in FIG. 7 from this angle. The conductive sheets 130 and 710 and the feeding microstrip lines 240 and 712 in the embodiment are designed according to the embodiment shown in FIG. 2. The other conductive sheets and feeding microstrip lines are designed according to the embodiment shown in FIG. 1. The corresponding design of the ground layer 740 and other elements are not described for concise purpose. For example, the antenna 700 in the embodiment can be used to form a 3×3 MIMO system which is needed by the wireless local area network (WLAN), and it also may be used in a part of a Bluetooth system. The antenna 700 in the embodiment occupies less area of the substrate 110, and it is adapted to be used in a small communication device. Moreover, the antenna 700 has a low cost.

FIG. 8 is a schematic diagram showing a communication device in an embodiment of the invention. As shown in FIG. 8, the communication device 800 in the embodiment includes a battery 810 and an antenna 820. The antenna 820 is the same to the antenna 700 in FIG. 7, but the antenna 820 can be replaced with the antenna in one of other embodiments in the invention. The element with big size in the communication device 800 is a battery 810. A casing of the battery 810 is usually made of metal which interferes with signal reception. For preferable signal reception effect, the battery 810 and the nearby conductive sheets 720 and 730 should be located at different surfaces of the substrate 110 (as shown in FIG. 1). However, the conductive sheet 130 relatively far away from the battery 810 can be located at the same surface of the substrate 110 with the battery 810. In addition, the communication device 800 further includes a display panel 830. The conductive sheet 130 near the display panel 830 and the display panel are located at different surfaces of the substrate 110 to avoid interfering with signal reception. The substrate 110 of the antenna 820 may be a main circuit board in a common communication device. Therefore, the area of the substrate 110 without the conductive sheet or the feeding microstrip line can be used to dispose other electronic elements. The communication device 800 may have other elements according to the design, and it is not described for concise purpose.

To sum up, in the invention, the conductive sheet used to receive and send signals in the antenna and the communication device is substantially perpendicular to the ground layer. Therefore, the area occupied by the conductive sheet on the substrate is reduced. Thus, the antenna is adapted to be used in a communication device which needs to reduce size. Even though the antennas are used in a MIMO system, the space of the communication device is not occupied too much. Moreover, the antenna in the invention has a low cost.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. An antenna comprising:
a substrate having an upper surface and a lower surface;
a ground layer disposed at the lower surface;
a first conductive sheet disposed at the substrate, substantially perpendicular to the ground layer and electrically connected to the ground layer; and
a first feeding microstrip line electrically connected to the first conductive sheet.

2. The antenna according to claim 1, wherein the first conductive sheet is bent to be L-shaped.

3. The antenna according to claim 1, wherein the ground layer has a groove which divides the ground layer into a first portion and a second portion, and the first conductive sheet is connected to the second portion.

4. The antenna according to claim 3, wherein the first conductive sheet is bent to be L-shaped, and the second portion is L-shaped.

5. The antenna according to claim 3, wherein the ground layer has an opening, the first feeding microstrip has a first end, a second end and a middle portion connected to the first end and the second end, the middle portion is at the upper surface, the first end passes through the substrate to be electrically connected to the second portion, and the second end passes through the substrate to be disposed at the opening.

6. The antenna according to claim 1, wherein the first conductive sheet is disposed at the upper surface and electrically connected to the ground layer via a conductive via passing through the substrate.

7. The antenna according to claim 6, wherein the ground layer has an opening, and the first feeding microstrip line passes through the substrate to be disposed at the opening.

8. The antenna according to claim 1, further comprising at least a second conductive sheet and at least a second feeding microstrip line, wherein the second conductive sheet is disposed at the substrate, substantially perpendicular to the ground layer and electrically connected to the ground layer, and the second feeding microstrip line is electrically connected to the second conductive sheet.

9. A communication device comprising:
a battery; and
an antenna including:
a substrate having an upper surface and a lower surface;
a ground layer disposed at the lower surface;
a first conductive sheet disposed at the substrate, substantially perpendicular to the ground layer and electrically connected to the ground layer, wherein the first conductive sheet and the battery are located at the upper surface and the lower surface of the substrate, respectively, or the first conductive sheet and the battery are located at the lower surface and the upper surface of the substrate, respectively; and
a first feeding microstrip line electrically connected to the first conductive sheet.

10. The communication device according to claim 9, wherein the first conductive sheet is bent to be L-shaped.

11. The communication device according to claim 9, wherein the ground layer has a groove which divides the ground layer into a first portion and a second portion, and the first conductive sheet is connected to the second portion.

12. The communication device according to claim 11, wherein the first conductive sheet is bent to be L-shaped, and the second portion is L-shaped.

13. The communication device according to claim 11, wherein the ground layer has an opening, the first feeding microstrip line has a first end, a second end and a middle portion connected to the first end and the second end, the middle portion is at the upper surface, the first end passes through the substrate to be electrically connected to the second portion, and the second end passes through the substrate to be disposed at the opening.

14. The communication device according to claim 9, wherein the first conductive sheet is disposed at the upper surface and electrically connected to the ground layer via a conductive via passing through the substrate.

15. The communication device according to claim 14, wherein the ground layer has an opening, and the first feeding microstrip line passes through the substrate to be disposed at the opening.

16. The communication device according to claim 9, wherein the antenna further comprises at least a second conductive sheet and at least a second feeding microstrip line, the second conductive sheet is disposed at the substrate, substantially perpendicular to the ground layer and electrically connected to the ground layer, and the second feeding microstrip line is electrically connected to the second conductive sheet.

17. The communication device according to claim 16, wherein the second conductive sheet and the battery are disposed at the upper surface or the lower surface of the substrate, and they are disposed in different areas of the upper surface or the lower surface, respectively.

18. The communication device according to claim 9, further comprising a display panel, wherein the first conductive sheet and the display panel are disposed at the upper surface or the lower surface of the substrate, and they are disposed in different areas of the upper surface or the lower surface, respectively.
